(19) United States
(12) Patent Application Publication
(10) Pub. No.: US 2014/0344249 A1
(43) Pub. Date: Nov. 20, 2014

(54) SIMPLE ACTION RECORD SEARCH

(71) Applicant: Vince Magistrado, Redlands, CA (US)

(72) Inventor: Vince Magistrado, Redlands, CA (US)

(21) Appl. No.: 13/895,252

(22) Filed: May 15, 2013

(51) Int. Cl. G06F 17/30

(52) U.S. Cl. CPC G06F 17/30554
USPC 707/722

(57) ABSTRACT

A method, apparatus and software related product (e.g., a computer readable memory) are presented for providing a single-action approach for initiating a record search, for example, in a list displayed in an electronic device (apparatus) such as a computer. The presented solution may provide a user with a single-action (single-click) capability to directly perform context-based (e.g., sender-based, recipient-based, subject-based, etc.) searches. From the user point of view, the presented solution may be intuitive enough having a low bar for discoverability, so that search results may be reached with relative ease, thus increasing pageview capabilities. Then manual creation of filters or typing terms in a search box is no longer necessary. The embodiments described herein may provide the user a quick and efficient way to search for messages and triage those messages for read, reply, deletion, or other actions.

### FIELD

The present disclosure relates to searching records/e-mails, and more specifically to using a single-action initiation of a record search.

### BACKGROUND

If an e-mail user wants to search for all e-mails from a given sender, the user must typically input the sender's email address in a search box and then perform a search with search results appearing (on a display) after search action is invoked. Similarly, if the user wants to search for all e-mails with a given subject line, the user must typically input the subject line's search terms in a search box and after that perform a search. Alternately, if the user has predefined filters made, the results may be found by clicking on folders belonging to the filters (the e-mail filters are typically defined by the user as a separate step before the intent to view filtered messages).

### SUMMARY

The present disclosure relates to methods, system and computer readable media useful for implementing improved mail search capability. Present mail systems familiar to most email users present emails in tabular form, generally in a list of emails presented with rows and columns delineating, respectively, email records, and parameters of the email records, such as the sender name, the recipient name, the date and time of sending or receipt, the subject line and other relevant information concerning each email record. Email records are generally stored on email systems, and may be referred to as email accounts, email boxes, or email repositories, all terms of which are interchangeable and are meant to denote a repository for the storing of email records received by or sent by a user of the email system.

In embodiments described herein, a familiar tabular email user interface is presented with rows and columns delineating email records and parameters of the email, the intersection of each row and column being referred to as an element. The system, either via the client device or the server individually or working in tandem, detects the presence or motion of a curser proximate one of the elements of the email user interface. Thus, for example, the user may direct the curser of a computing device that is currently displaying or interacting with the mail system, and cause the curser to enter an area proximate one of the elements of the email user interface. Thus, by directing the curser proximate the name of a sender of an email which would appear in a user's inbox, that navigation proximate that element would cause the initial appearance of an icon in a first state. The appearance or changing of the icon element of the first instance causes the user's attention to focus on that icon that has either initially appeared or changed as a result of the proximate navigation of the pointing device. The user may then interact with the icon by clicking, double clicking, holding the curser over the icon for a certain period of time, or perform other single action activities relative to the icon which would cause the system to recognize that single action input as a request to perform a search. The search result would be received and cause the user interface to display a modified list of items that would be responsive to and/or similar to the information in the element containing the search icon that was interacted with. Thus, for example, the user would navigate to the name of a sender, the icon would appear, the user would click the icon, and that single action would cause a search to be initiated. The search would be a search of the user's email account, or inbox, or outbox, or all of the emails in the users account, that would contain the name of the sender, which search would be executed in a matter known in the art to produce the search result being responsive to the search term, the search term matching the information in the user interface element that contained the icon. This technique could be used to produce search results based upon searching for senders, recipients, email address, subject information, dates or times, or even potentially the size of emails. In short, any parameter found in a column of the email user interface may be utilized to effectuate the search for records in the email system that match that selected parameter.

This single action search technique, while disclosed herein relative to an email system, is applicable to any system that presents records in an account or database and facilitates single action searching on relevant database parameters via a simple easy to navigate user interface.

The creation of the search can proceed in a number of difference ways, such as, for example, by the search system extracting the text in the database or tabular user interface element such as, the name of a sender, or the name contained in a database record, email addresses in the table at the element location, metadata and creating a search string to be fed to a search engine via a URL, command line search instruction, or other recognized technique for passing a query to a search engine.

In various embodiments the search result is presented to the user utilizing the same general tabular structure, with the search results presented, in an embodiment, in date order, with the most recently received email or most recently updated database record appearing at the top. Of course, such search results can be sorted in a variety of different ways depending on user preference, and may contain more or fewer email records than originally displayed at the time of the input action being performed.

Also, the technique can be optionally applied in an iterative matter, so that once a search result is received and the modified list of database records or email records appear in a list, the same technique can be applied to further sort and refine the search result to produce an even narrower result, whereby the user would interact with an icon in an element of the user interface while the modified list is being presented, and the search result would be the result of a search performed on the modified list as opposed to the entire database of records.

The simple user interface disclosed is easily adapted from devices with cursers and pointing devices such as laptop computers, desktop computers and the like, to haptic or touch-screen devices such as smart phones, tablets and/or computers with combination touch-screen and keyboard/curser interface mechanisms. Thus, in a touch-screen environment, the search can be initiated by tapping, swiping or holding ones finger down on the element of the tabular user interface that a user wishes to perform the search on. This would be an analogous to the clicking of an icon as described above. Of course, the appearance of the icon could also be triggered by the proximity of the user's finger or stylus to cause the icon to appear as the user's finger or stylus or other device interfaces with the touch-screen is navigated proximate the element to be searched., or the icon may be optional and mere interaction with the element would trigger the search. These and other embodiments will be described in further detail below.

A first aspect consists of receiving by an electronic device through a user interface a single-action command representing the selection of an element of a table, the table comprising columns, rows and elements of a list of records, where each row corresponds to one record of the list of records and each column corresponds to a predetermined parameter common to all records in the list of records; and generating by the electronic device, in response to the single-action command, a modified list of records selected from the list of records based on a similarity between the selected element and corresponding elements in the list of records in a column comprising the selected element.

In another aspect, the single-action command is received by detecting a movement of a cursor to an area proximate the element to be selected, and detecting clicking on a search icon that appears proximate the element.

In another aspect, the single-action command is received by detecting the movement of a cursor to an area proximate the element to be selected and detecting an action from a group of actions consisting of: a click in the area of the element, a long click in the area of the element, and a double click in the area of the element.

In another aspect, the electronic device comprises a touch screen used as the user screen interface, and the single-action command is received by detecting a preselected touch proximate the element to be selected.

In another aspect, the single-action command is received by the preselected touch proximate the element to be selected by detecting an action from a group of actions consisting of: a tap in the area of the element, a touch for a preselected time in the area of the element, and a swipe in the area of the element.

In another aspect, generating a modified list of records selected from the list of records comprises: searching a memory of the electronic device storing the list of records to generate the modified list.

In another aspect, generating a modified list of records selected from the list of records comprises: sending a search command comprising information corresponding to the selected element to a server device storing the list of records; and receiving from the server device information comprising the modified list of records.

Another aspect consists of displaying the generated modified list of records on a display of the electronic device.

Another aspect consists of receiving by the electronic device through the user interface a further single-action command selecting a further element of the modified list, the further element being different from the selected element; and generating by the electronic device, in response to the further single-action command, a further modified list of records selected from the modified list of records based on similarity between the further element and corresponding elements in the modified list of records in a column comprising the selected further element.

In another aspect, the list of records comprises a list of e-mails.

In another aspect, the selected element comprises an e-mail sender's identity.

In another aspect, the selected element comprises a subject of the e-mail.

In another aspect, an apparatus comprising: a processor; a storage medium for tangibly storing thereon program logic for execution by the processor, the program logic comprising: logic to receive through a user interface a single-action command representing the selection of an element of a table, the table comprising columns, rows and elements of a list of records, where each row corresponds to one record of the list of records and each column corresponds to a predetermined parameter common to all records in the list of records; and logic to generate, in response to the single-action command, a modified list of records selected from the list of records based on a similarity between the selected element and corresponding elements in the list of records in a column comprising the selected element.

In another aspect, the apparatus comprises a computer, a smartphone, a tablet or a wireless device.

In another aspect, the program logic comprises: logic to detect a movement of a cursor to an area proximate the element to be selected, and detecting clicking on a search icon that appears proximate the element.

In another aspect, the apparatus comprises a touch screen used as the user interface, and the program logic comprises: logic to receive the single-action command by detecting a preselected touch proximate the element to be selected.

In another aspect, the program logic comprises: logic to search a memory or a cache memory of the apparatus storing the list of records to generate the modified list.

In another aspect, the program logic comprises: logic to send a search command to a server device storing the list of records; and logic to receive from the server device information comprising the modified list of records.

In another aspect, the program logic comprises: logic to display the generated modified list of records on a display of the apparatus.

In another aspect, the list of records comprises a list of e-mails.

In another aspect, a non-transitory computer readable storage medium tangibly stores computer program instructions capable of being executed by a computer processor, the computer program instructions defining code for: receiving by an electronic device through a user interface a single-action command representing the selection of an element of a table, the table comprising columns, rows and elements of a list of records, where each row corresponds to one record of the list of records and each column corresponds to a predetermined parameter common to all records in the list of records; and generating by the electronic device, in response to the single-action command, a modified list of records selected from the list of records based on a similarity between the selected element and corresponding elements in the list of records in a column comprising the selected element.

Another aspect consists of detecting a single-action command from a user interface of a computing device, the command representing the selection of an element of a table that comprises columns, rows and elements of a list of records, each row of the table corresponding to one record of the list of records and each column of the table corresponding to a predetermined parameter common to all records in the list; automatically formulating, via the computing device, a search query comprising the selected element; communicating the search query to a search program capable of searching the list of records based on similarity between the selected element and corresponding elements in the list of records in a column comprising the selected element; and receiving, in response to the search query, a search result comprising a modified list of records selected from the list of records in accordance with the query.

In another aspect, a computing device comprising; a processor; and memory for storing program logic, the program logic executed by the processor, the program logic comprising: logic for detecting a single-action command from a user interface of a computing device, the command representing the selection of an element of a table that comprises columns, rows and elements of a list of records, each row of the table corresponding to one record of the list of records and each column of the table corresponding to a predetermined parameter common to all records in the list; logic for automatically formulating, via the computing device, a search query comprising the selected element; logic communicating the search query to a search program capable of searching the list of records based on similarity between the selected element and corresponding elements in the list of records in a column comprising the selected element; and logic for receiving, in response to the search query, a search result comprising a modified list of records selected from the list of records in accordance with the query.

Another aspect consists of receiving by an electronic device through a user interface a single-action command representing the selection of an element of a table, the table comprising columns, rows and elements of a list of records, where each column corresponds to one record of the list of records and each row corresponds to a predetermined parameter common to all records in the list of records; and generating by the electronic device, in response to the single-action command, a modified list of records selected from the list of records based on a similarity between the selected element and corresponding elements in the list of records in a row comprising the selected element.

In another aspect, after detecting a movement of a cursor to an area proximate the element to be selected, the method further comprising: providing a search icon proximate the element, an interaction of the user with the icon providing the single-action command.

In another aspect, after detecting a user interation at an area proximate the element to be selected, the method further comprising: providing a search icon proximate the element, an interaction of the user with the icon providing the single-action command.

In another aspect, the user interaction is an interaction chosen from a group of interactions consisting of a slide, a sweep, a tap, a held position, and a touch.

### BRIEF DESCRIPTION OF THE DRAWINGS

For a better understanding of the nature and objects of the exemplary embodiments, reference is made to the following detailed description taken in conjunction with the following drawings. In the drawing figures, which are not to scale, and where like reference numerals indicate like elements throughout the several views:

FIG. 1 is a flow chart illustrating an exemplary embodiment for implementation of a single-action selection command;

FIGS. 2a-2e are examples of a user interface for generating a modified list of e-mails based on selecting a Sender using a single-action selection command illustrated in FIG. 1, according to an embodiment;

FIGS. 3a-3i are examples of a user interface for generating a modified list of e-mails based on selecting a Recipient (1^{st} selection, FIGS. 3a-3e) and on further selecting a Subject (2^{nd} selection, FIGS. 3f-3i) using a single-action selection command illustrated in FIG. 1, according to further embodiments;

FIG. 4 is a flow chart illustrating implementation of various embodiments by an electronic device (e.g., computer);

FIG. 5 is a block diagram illustrating an apparatus/electronic device for implementation of various embodiments.

FIG. 6 illustrates an exemplary internal architecture of a computing device for implementing embodiments described herein; and

FIG. 7 is an exemplary schematic diagram illustrating a client device implementation of a computing device for implementing embodiments of the present disclosure.

### DESCRIPTION OF EMBODIMENTS

Embodiments are now discussed in more detail referring to the drawings that accompany the present application. In the accompanying drawings, like and/or corresponding elements are referred to by like reference numbers/characters throughout the drawings.

Various embodiments are disclosed herein; however, it is to be understood that the disclosed embodiments are merely illustrative of the disclosure that can be embodied in various forms. In addition, each of the examples given in connection with the various embodiments is intended to be illustrative, and not restrictive. Further, the figures are not necessarily to scale, some features may be exaggerated to show details of particular components (and any size, material and similar details shown in the figures are intended to be illustrative and not restrictive). Therefore, specific structural and functional details disclosed herein are not to be interpreted as limiting, but merely as a representative basis for teaching one skilled in the art to variously employ the disclosed embodiments.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

The present disclosure is described below with reference to block diagrams and operational illustrations of methods and devices to select and present media related to a specific topic. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer, special purpose computer, ASIC, or other programmable data processing apparatus, such that the instructions, which execute via the processor of the computer or other programmable data processing apparatus, implements the functions/acts specified in the block diagrams or operational block or blocks.

In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved. Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

Throughout the specification and claims, terms may have nuanced meanings suggested or implied in context beyond an explicitly stated meaning Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

As stated herein, using conventional approaches for initiation of a list search in an electronic device such as a computing device will require multiple commands for the user to obtain desired search results, where the search is invoked from places in the UI (user interface) outside of a list of records (messages).

A method, apparatus and software related product (e.g., a computer readable memory or storage device) are presented for providing a single-action approach for initiating a record search, for example, in a list displayed in an electronic device (apparatus) such as a computer. The presented solution may provide a user with a single-action (e.g., single-click) capability to directly perform context-based (e.g., sender-based, recipient-based, subject-based, etc.) searches. From the user point of view, the presented solution is intended to be intuitive enough to have a low bar for discoverability, so that search results may be reached with relative ease, thus increasing pageview capabilities. Manual creation of filters or typing terms in a search box is no longer necessary. The embodiments described herein are intended to provide the user a quick and efficient way to search for messages and triage those messages for reading, reply, deletion, or other actions.

According to one embodiment, an electronic device such as a computer (or a client electronic device in general) may receive through a user interface (or user screen interface) a single-action command selecting an element (one element) of a table which comprises columns, rows and elements of a list of records. In depicted embodiments and examples, the database may be a user's email account and records could be undelivered emails associated with that account. Each row may correspond to one record (such as e-mail) of the list of records and each column may correspond to a predetermined parameter (e.g., sender, recipient, subject, etc.) common to all records in the list. In response to the single-action command, the electronic device may generate or initiate a search that comprises all or part of the selected column parameter. A search is performed responsive to the search report in order to return a modified list of records selected from the list of records based on similarity between the selected element and corresponding elements in the list of records in a column comprising the selected one element to the selected element. The modified list (search results page for the selected element such as sender, subject or the like) is displayed via the electronic device in a format similar to the original list of records and optionally maintains the same number of columns.

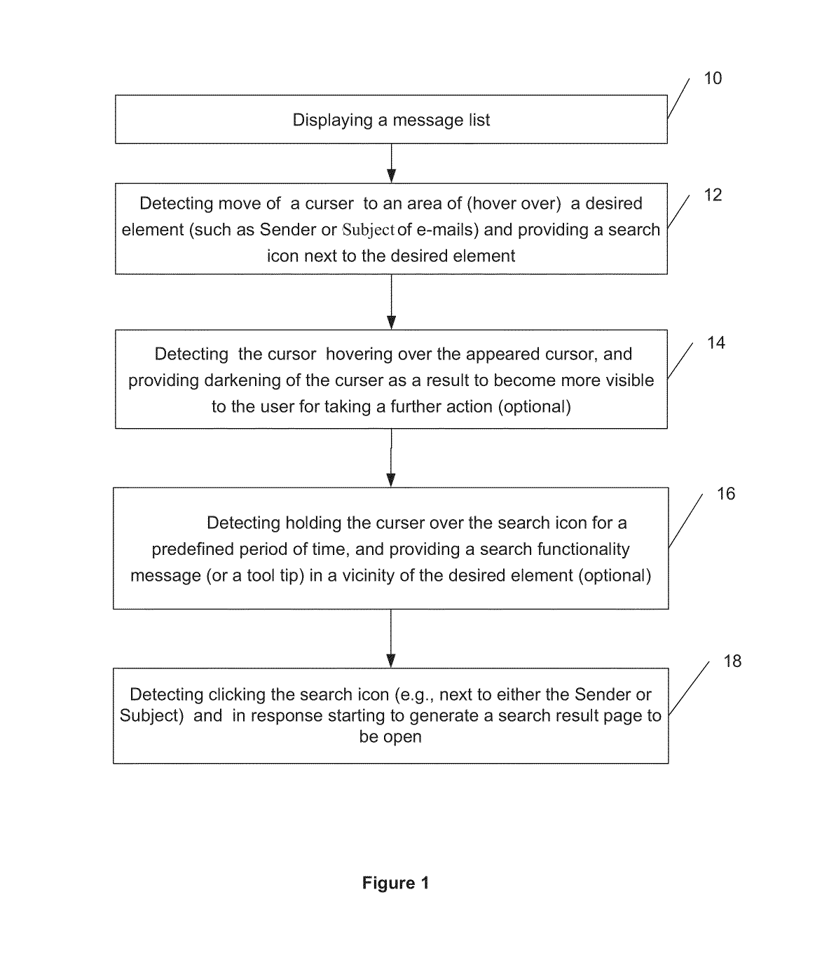

It is noted that for the purpose of the present disclosure, the term “single action command” means that the user need provide only one command (a click, touch, tap, etc. as described herein) to the electronic device to initiate the search and result functionality described herein. The optional sub-steps shown and discussed for example with respect to FIG. 1 inter alia relating to cursor movement, changing or causing the appearance of an icon, the presentation of tool tips and the like are differentiated from user commands, as these are optional features intended for the purpose of assisting the user to implement the described and claimed single action command quickly and efficiently.

According to a further embodiment, the content of rows and columns may be interchanged, so that each column may correspond to one record and each row may correspond to a predetermined parameter (e.g., sender, recipient, subject or the like) common to all records. Then the modified list of records may comprise a smaller number of columns (or records) while maintaining the same number of rows, or may be in a different format, with different columns, with fewer elements, or the results might only contain metadata or thumbnails.

It should be further appreciated that the selection process could be iterative, and may continue after generating the first modified list of records. For example, in yet another embodiment, after displaying the generated list of records, the electronic device may receive through the user interface a further single-action command selecting a further element (different from the selected one element, e.g., from another column) of a further table which comprises columns and rows of the modified list of records. In response to the further single-action command, the electronic device may generate a further modified list of records selected from the previously generated modified list of records based on similarity between the selected further element and corresponding elements in the modified list of records (in a column comprising the selected further element). Then the further modified list may be displayed via the electronic device with a smaller number of rows (or records) than the modified list of records but optionally maintaining the same number of columns. Then the “drill down” process of selection may continue further as described herein to select an element yet from another column.

Different implementation options are further discussed in reference to a single-action command. There are many possible implementation scenarios. According to one exemplary embodiment as demonstrated in FIG. 1, when viewing the message list on a computer screen in step 10, the user in step 12 may move a curser to (hover over) an area in proximity or proximate a desired element (such as Sender or Subject of a particular e-mail) in the intersection of a certain row and a certain column. This may trigger the initial appearance of an icon (called a search icon) next to the desired element. In an embodiment the icon is initially “hinted” such that the icon may be first displayed in outlined or as a shaded element for example in light gray. When the user moves the cursor to hover over the icon in step 14, the curser may darken or otherwise change state (this may be an optional feature) to become more visible to the user for taking a further action. Other options may include the icon changing size, shape or color. In addition, after holding the curser over the search icon for a predefined period of time in optional step 16, a search functionality message or a tool tip (to further assist the user) may appear in a vicinity of the desired element. Then in step 18 the search icon (e.g., next to either the Sender or Subject) may be clicked or otherwise interacted with by a single action, triggering a search result page to be presented that contains emails from the Sender for the former, or for the Subject for the latter.

It is noted that the order of steps shown in FIG. 1 is not required, so in principle, the various steps may be performed out of the illustrated order. Also certain steps may be skipped, different steps may be added or substituted, or selected steps or groups of steps may be performed in a separate application following the embodiments described herein.

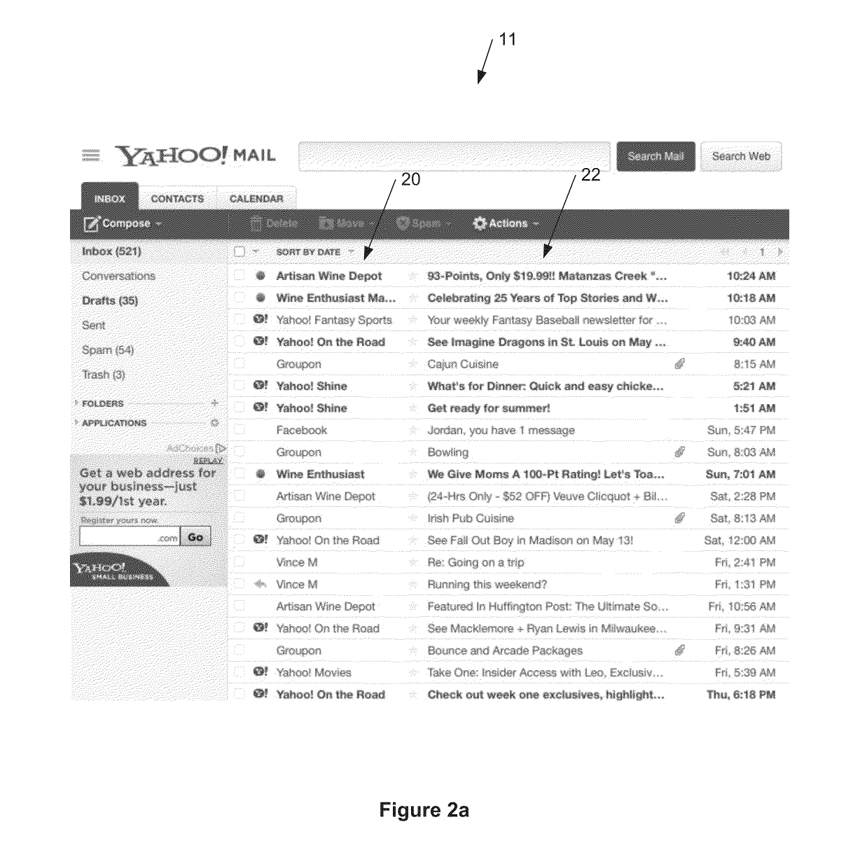

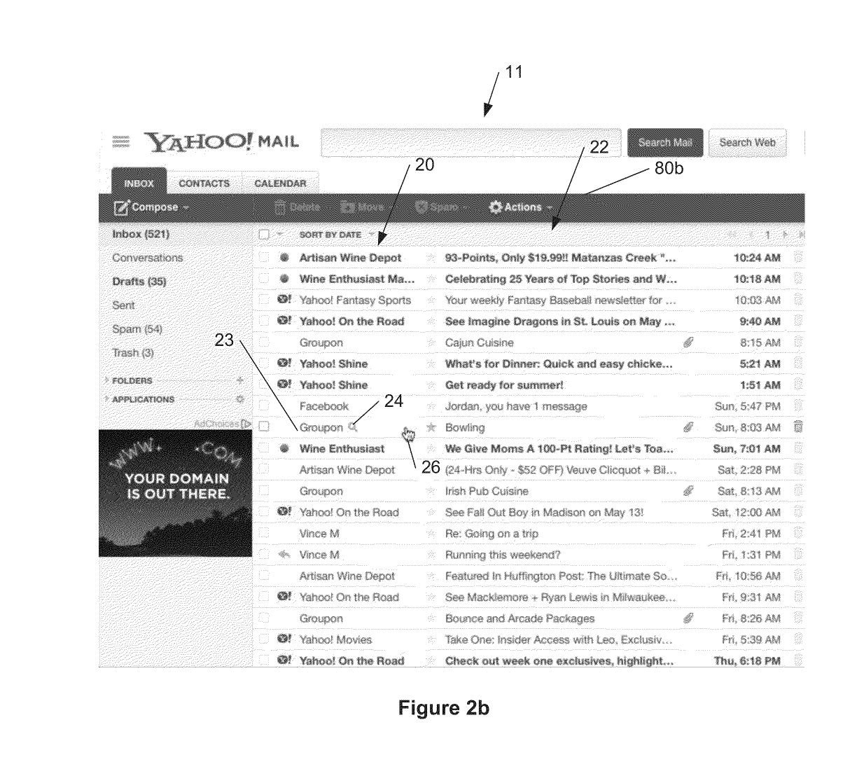

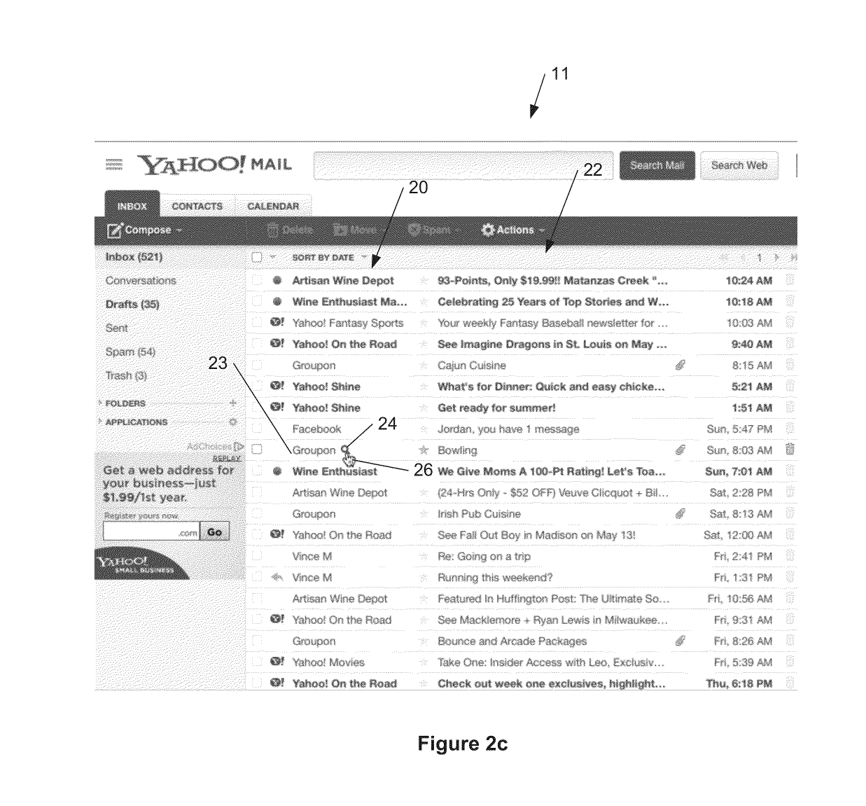

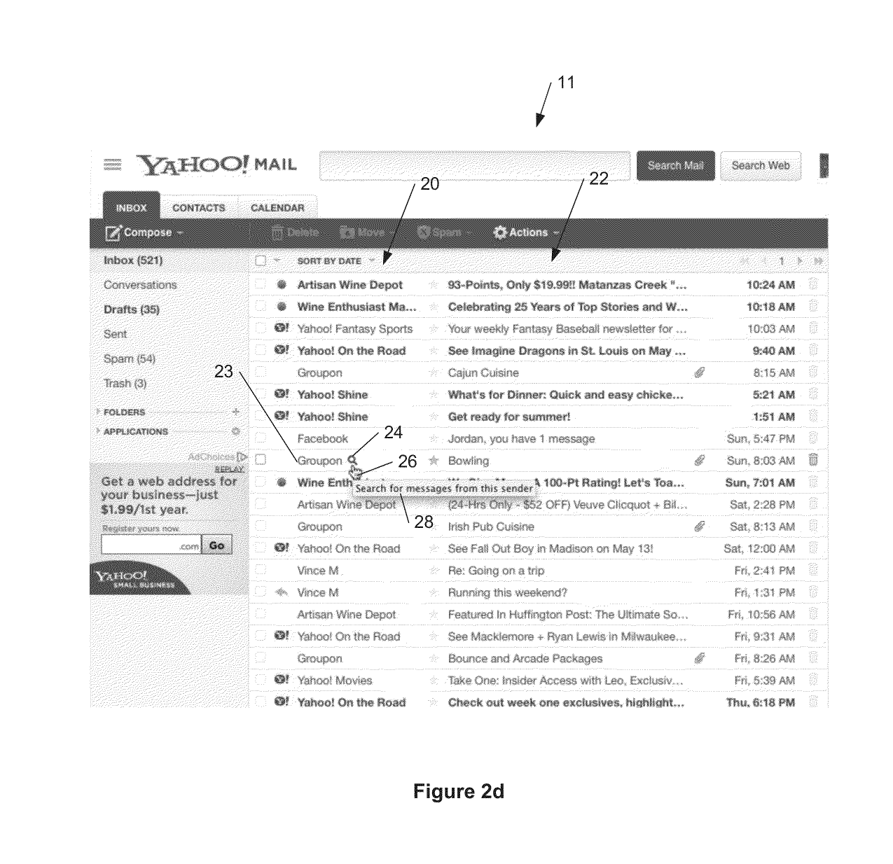

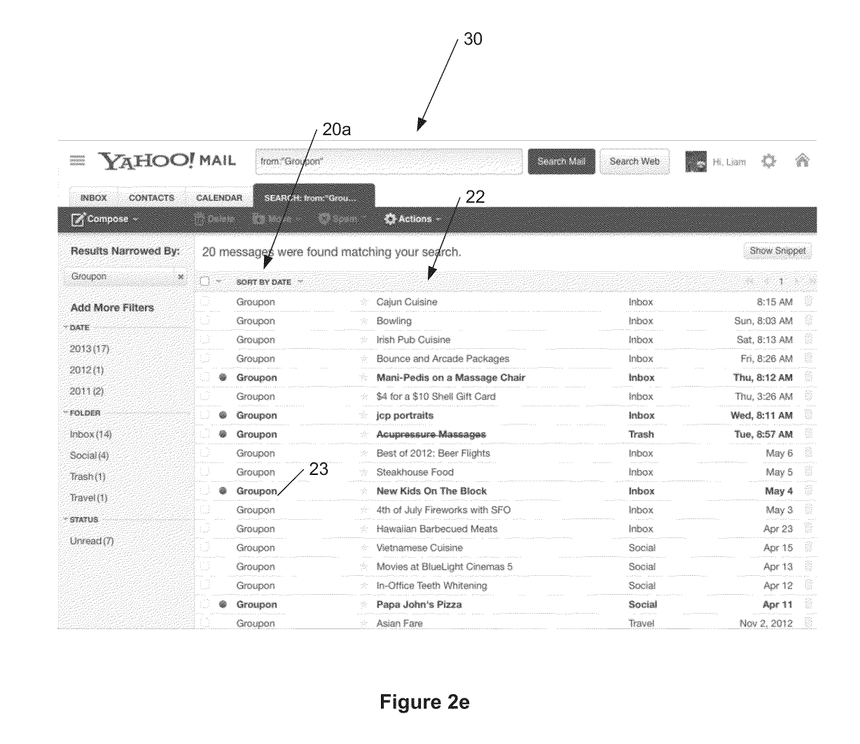

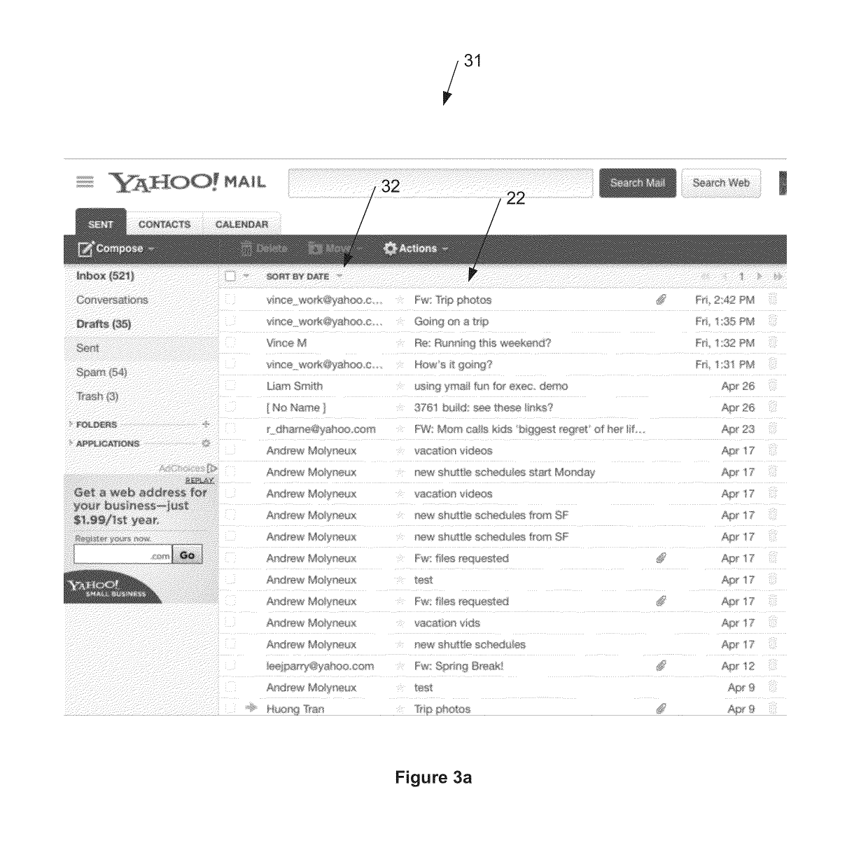

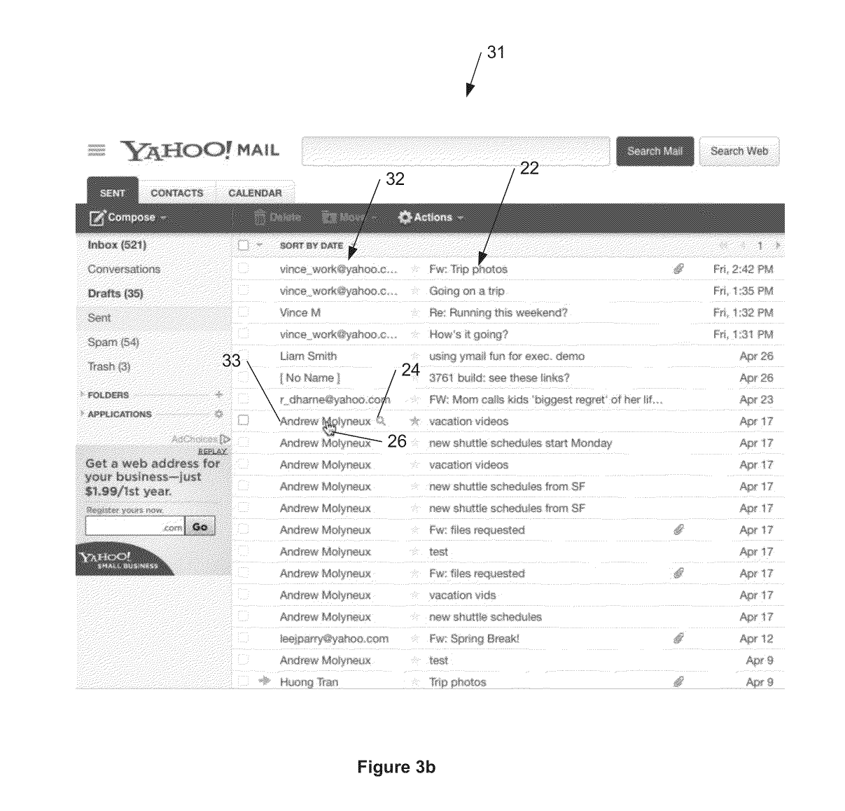

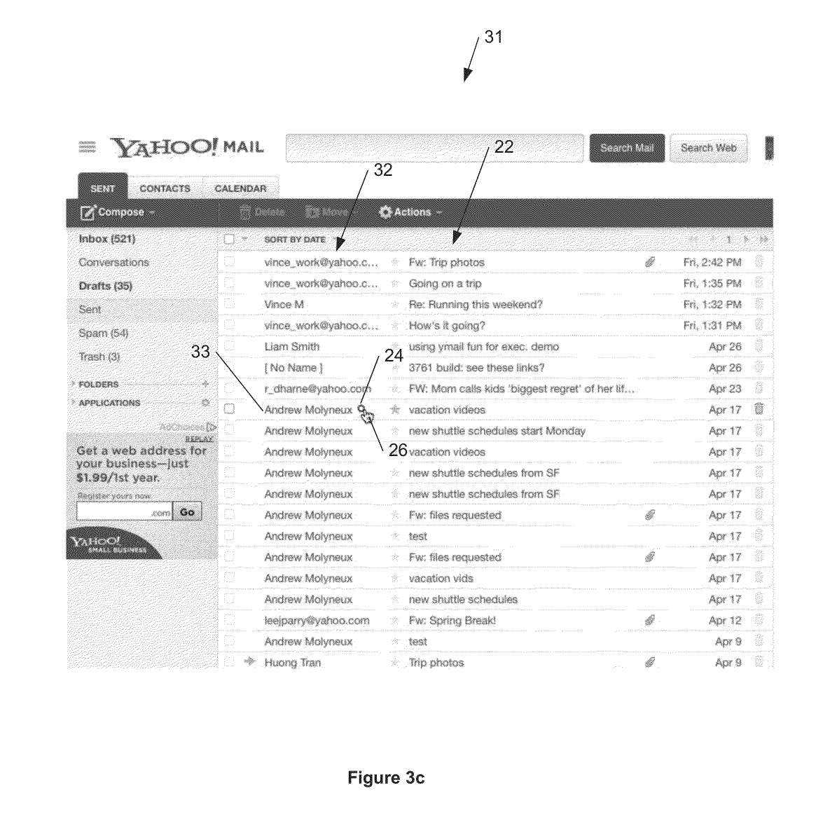

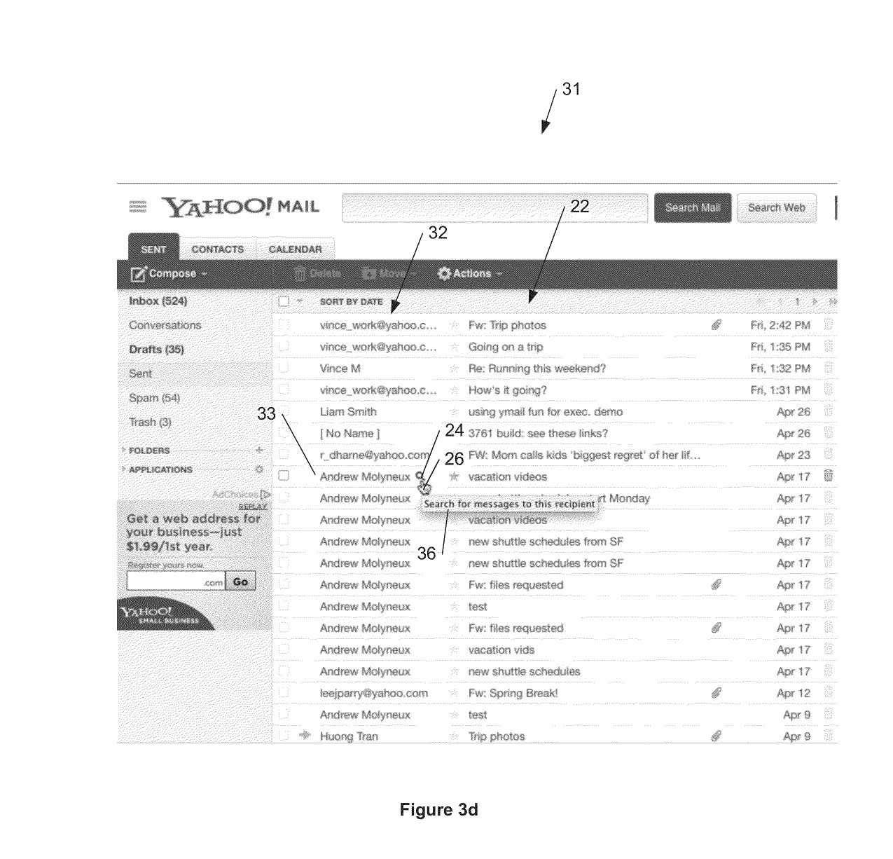

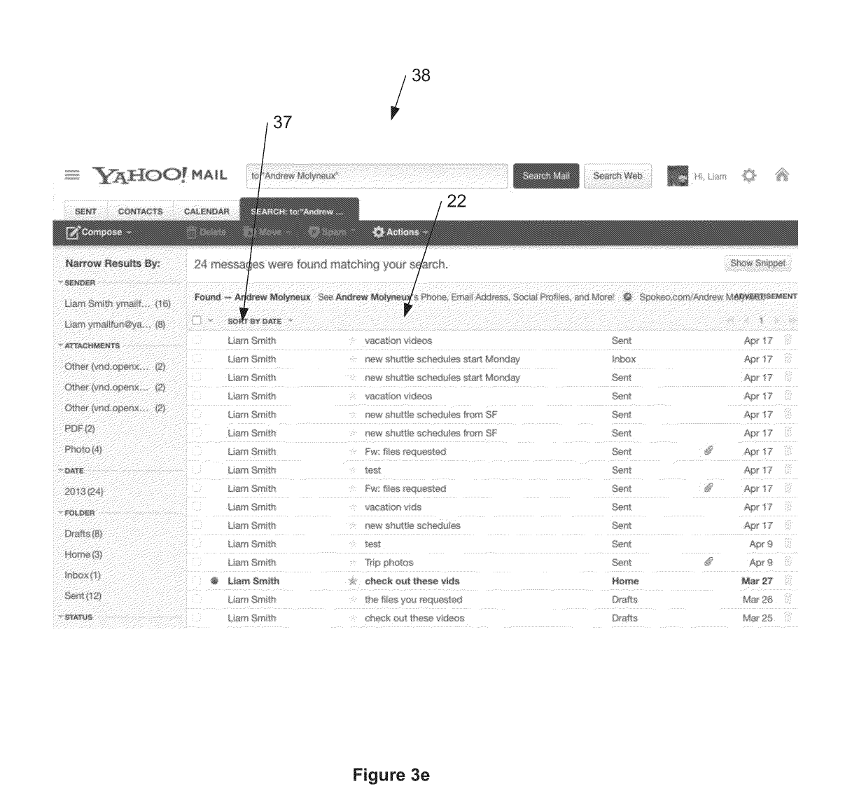

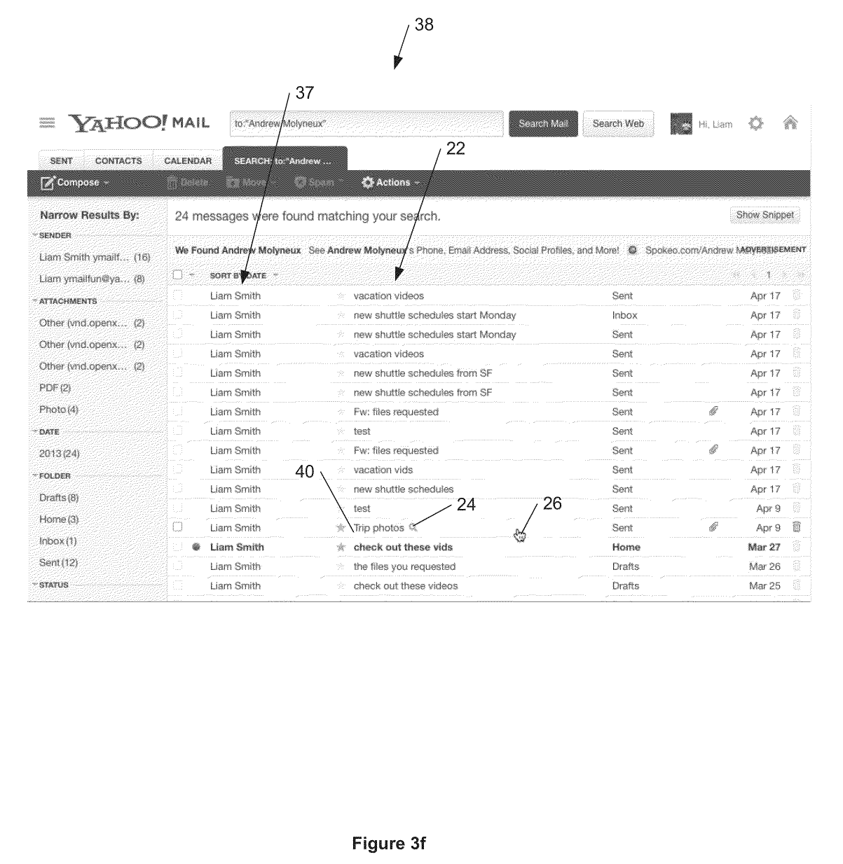

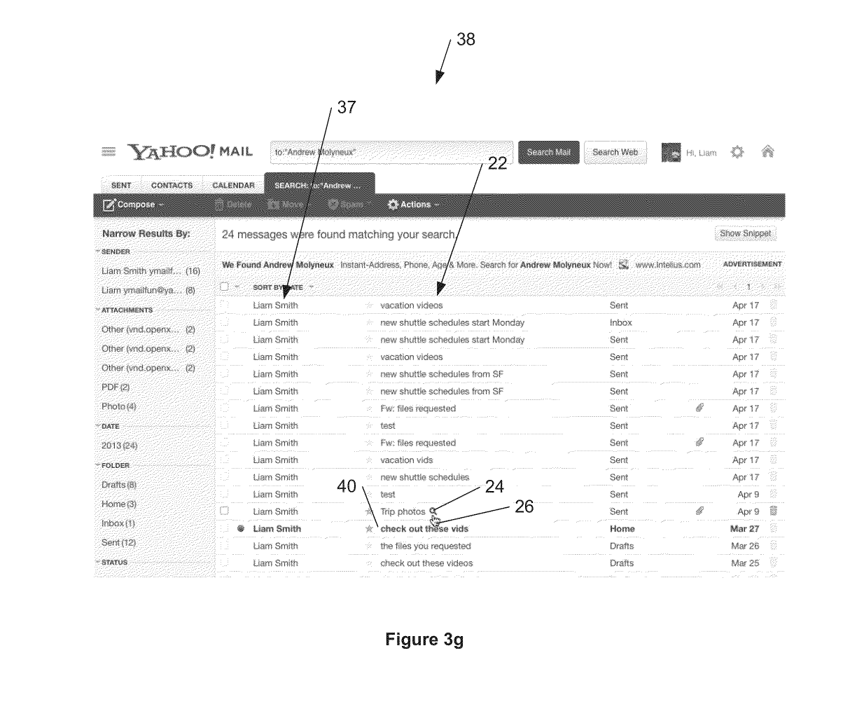

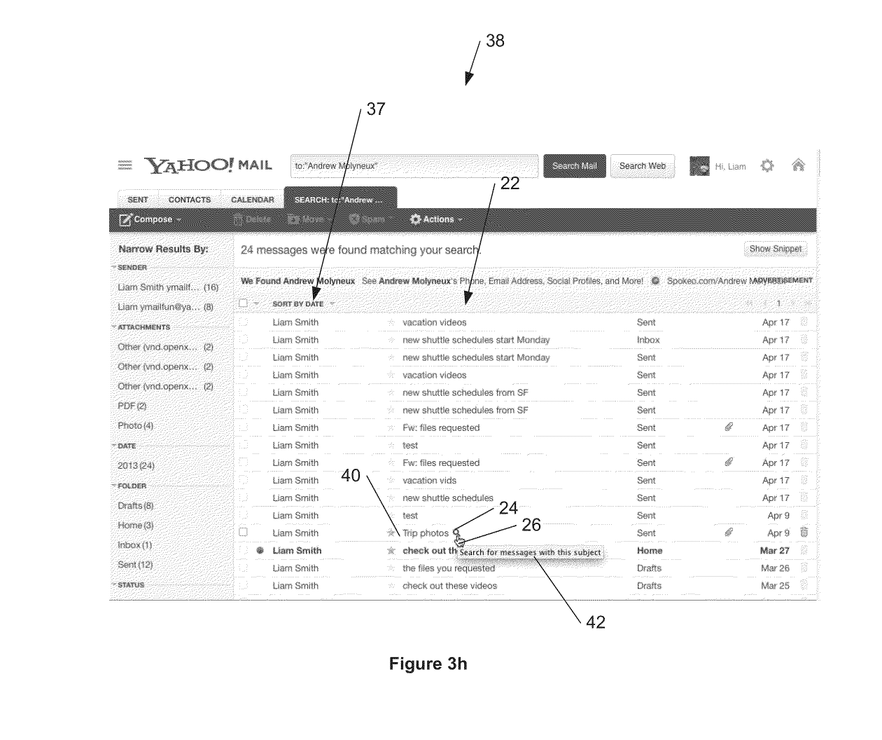

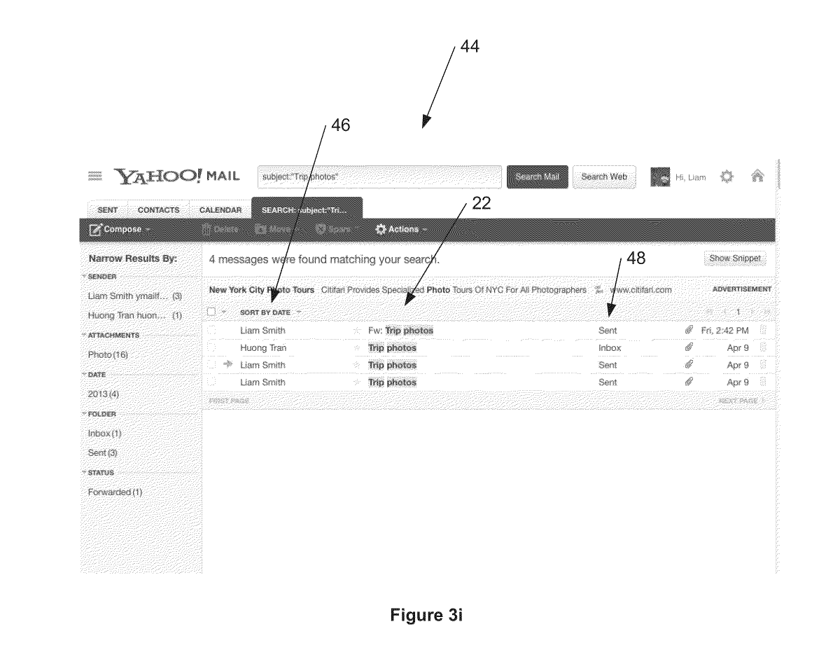

FIGS. 2a-2e and 3a-3i demonstrate various implementation alternatives of the present disclosure.

FIGS. 2a-2e show user interface examples which demonstrate generating a search result comprising a modified list representing a responsive subset of e-mails based on selecting a desired Sender using a single-action selection command illustrated in FIG. 1, according to one embodiment. FIG. 2a shows a fragment of a typical inbox e-mail list 11 comprising 521 unread messages having at least a sender column 20 and a subject column 22. In FIG. 2b it is shown that a search icon 24 (light gray) is revealed for the sender Groupon 23 as a result of moving (by the user) a curser 26 close to or proximate a desired element Goupon 23 (via movement or by hovering) per step 12 of FIG. 1.

FIG. 2c shows a result of performing an optional step 14 of FIG. 1 where the cursor 26 is moved to hover over the icon 24, which darkens as a result to become more visible to the user or to increase user focus on the icon so as to facilitate a further action. In addition, after holding the curser 26 over the search icon 24 for a predefined period of time per optional step 16 of FIG. 1, a tool tip 28 may further appear in a vicinity of the desired element 23 as shown in FIG. 2d. Then per step 18 of FIG. 1 the search icon 26 is clicked thus triggering a search result page 30 to open showing only selected e-mails sent (in the depicted example) by sender Groupon 23 as depicted in FIG. 2e.

FIGS. 3a-3i show examples which demonstrate generating a search result comprising a modified list representing a responsive subset of e-mails based on selecting a desired Recipient (1^{st} selection, FIGS. 3a-3e) and on further selecting a desired Subject (2^{nd} selection, FIGS. 3f-3i) using the single-action selection command illustrated in FIG. 1, according to further embodiments. FIG. 3a shows a fragment of a typical sent e-mail list 31 comprising 521 unread messages and having at least a recipient column 32 and a subject column 22. In FIG. 3b it is shown that a search icon 24 (light gray) is revealed for the recipient Andrew Molyneux 33 as a results of moving (by the user) a curser 26 close to a desired element Andrew Molyneux 33 (to hover over) per step 12 of FIG. 1.

FIG. 3c shows a result of performing an optional step 14 of FIG. 1, where the cursor 26 is moved to hover over the icon 24, which darkens as a result to be more visible to the user to take a further action. In addition, after holding the curser 26 over the search icon 24 for a predefined period of time per optional step 16 of FIG. 1, a tool tip 36 may further appear in a vicinity of the desired element 33 as shown in FIG. 3d. Then per step 18 of FIG. 1 the search icon 26 is clicked thus triggering a search result page 38 to open with only selected 24 e-mails from Liam Smith (column 37) as depicted in FIG. 3e (not all selected e-mails are shown in FIG. 3e). It is further noted that page 38 shows a sender column 37 so that coincidently all e-mails received by the recipient Andrew Molyneux 33 are predominantly from the same sender Liam Smith.

FIGS. 3f-3i demonstrate a 2^{nd} or further selection of a Subject using the starting page 37 shown in FIG. 3e as a continuation of the selection process started in FIG. 3a. It is shown in FIG. 3f that a search icon 24 (light gray) is revealed for the Subject 40 (Trip photos) as a result of moving by the user a curser 26 proximate a desired element Trip photos 40 (via movement or hovering) per step 12 of FIG. 1. FIG. 3g shows a result of performing an optional step 14 of FIG. 1, where the cursor 26 is moved to hover over an icon 24, which is darkened or otherwise changed as a visual indicator to be more visible to the user. In addition, after holding the curser 26 over the search icon 24 for a predefined period of time per optional step 16 of FIG. 1, a tool tip 42 further appears in a vicinity of the desired element 40 (Trip photos) as shown in FIG. 3h. Then per step 18 of FIG. 1 the search icon 26 is clicked thus triggering a search result page 44 to open as depicted in FIG. 3i with only selected 4 e-mails (column 46) corresponding to the selected subject “Trip photos” including 3 e-mails sent by Liam Smith and one e-mail sent by Huong Tran (see column 48).

According to further embodiments, the above examples may be modified and/or simplified in many ways. For example, the single-action command may be provided in the most simple implementation by moving a cursor to an area (hovering the area) of the one element to be selected causing an icon next to the one element to appear, and then simply clicking on the icon appeared next to the one element (thus skipping steps of darkening of the search icon and the appearance of a search functionality message when the cursor hovers the icon). Alternatively, the single-action command may be provided by moving a cursor to an area of the desired element (to be selected) and performing a long click proximate or on the icon of the one element, or performing a double click in the area of or on the icon of the desired element, etc. Alternatively, the element itself (sender, recipient, subject or other parameter) maybe directly clicked, tapped, pressed or otherwise selected directly without the need for an icon to appear.

Moreover, the approach described herein may be extended to touch capable electronic devices having a touch screen/display, substituting by way of non-limiting examples, clicks with touches and/or hovers with swipes. Thus if the electronic device comprises a touch screen used as the user interface, the single-action command may be provided by touching or swiping the one element to be selected using various scenarios as described above for the cursor implementation.

Furthermore, generating a modified list of records selected from the list of records may comprise searching a memory or a cache memory of the electronic device (computer) storing the list of records to generate the modified list. Alternatively, since the list of records can also be stored in a server device, the electronic device may send a search command to the server device to select corresponding records (such as e-mails from a user's email account) for generating the modified list of records. The search command, in an embodiment, may comprise a search string or term or terms comprising the information found in the display element at the selected column and row location, such as the sender or recipient name or the words in a subject line. After receiving from the server device information comprising the modified list of records, it may be displayed in the electronic device as a new page. Even if only a portion of the list of records is stored locally in the electronic device (e.g., in the cache memory), the electronic device may still send a search command to the server device for generating the modified list of records which may provide easier and more reliable implementation.

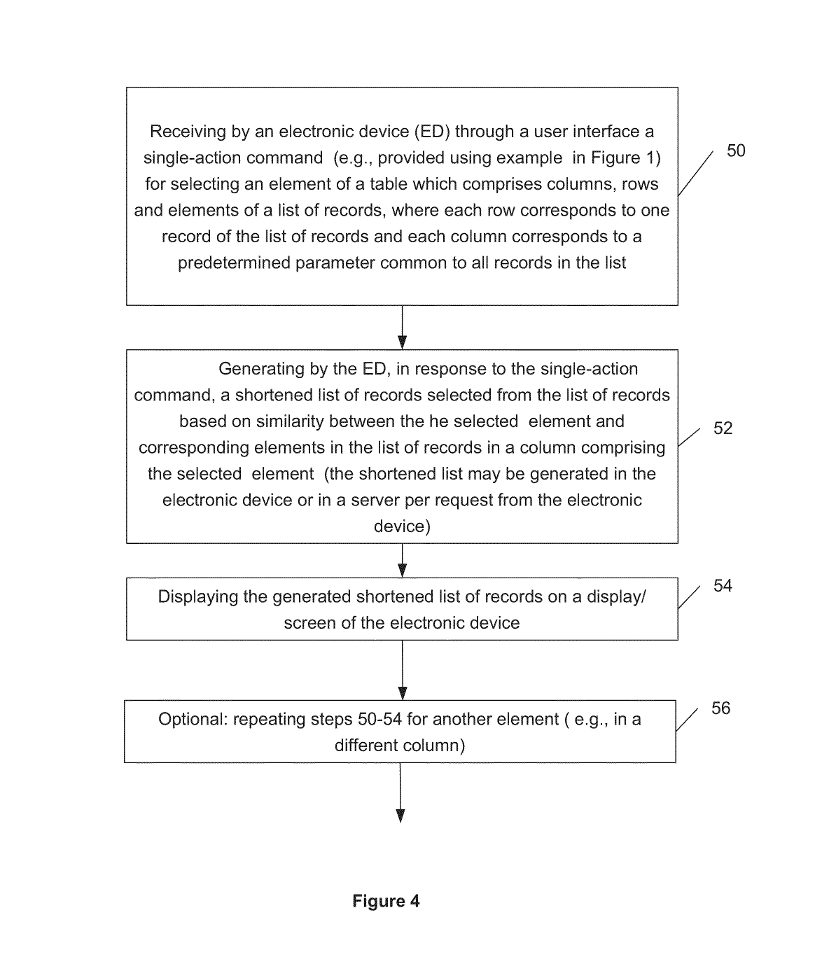

With reference now to FIG. 4, shown is a flow chart demonstrating implementation of the various illustrated embodiments. It is noted that the order of steps shown in FIG. 4 is not required, so in principle, the various steps may be performed out of the illustrated order. Also certain steps may be skipped, different steps may be added or substituted, or selected steps or groups of steps may be performed in a separate application following the embodiments described herein.

In a method according to the embodiment shown in FIG. 4, in a first step 50, an electronic device (apparatus such as computer) receives through a user interface a single-action command (e.g., provided using the example described in connection with prior figures) for selecting at least one element of a table which comprises columns, rows and elements of a list of records, where each row corresponds to one record of the list of records and each column corresponds to a predetermined parameter common to all records in the list. In the depicted example set forth previously, a data record represents an e-mail in a user's e-mail account or mailbox, and the columns represent parameters in the e-mail such as sender, recipient and subject information and the like.

In a next step 52, the electronic device, in response to the single-action command, generates a modified list of records selected from the list of records based on similarity between the selected element and corresponding elements in the list of records in a column comprising the selected one element (the modified list may be generated in the electronic device or in a server device per request from the electronic device). In a next step 54, the electronic device displays the generated modified list of records on a display/screen of the electronic device. Then in an optional step 56, the procedure may be used again by repeating steps 50-54 for another selected element (e.g., in a different column).

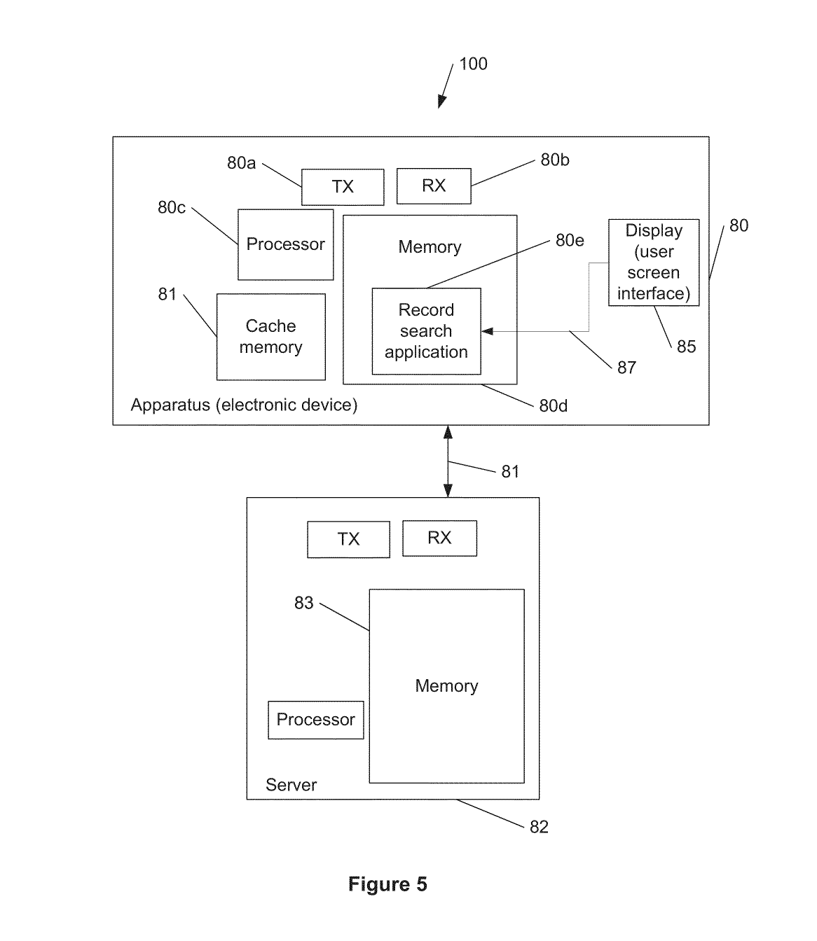

FIG. 5 shows an exemplary embodiment of an electronic device (apparatus) 80 and a server device 82 in a system 100 (e.g., a wireless or wired network). The apparatus 80 may be a computer, a smartphone, an ipod®, a tablet, a wireless device and the like. FIG. 5 is a simplified block diagram of various electronic devices that are suitable for practicing the exemplary embodiments; components of an electronic device are configured to cause that electronic device to operate.

The apparatus 80 may comprise, e.g., at least one transmitter 80a, at least one receiver 80b, at least one processor 80c at least one memory 80d, a cache memory 81 and a record search application module 80e. The transmitter 80a and the receiver 80b may be configured to provide a wireless or wired communication with the server device 82 (e.g., through a corresponding link 81) to search for selected records stored in the memory 83 of the server device 82 according to the embodiments described herein. The transmitter 80a and the receiver 80b may be generally means for transmitting/receiving and may be implemented as a transceiver, or a structural equivalence thereof. It is further noted that the same requirements and considerations are applicable to transmitter and receiver of the server 82.

Various embodiments of the at least one memory 80d (e.g., computer readable memory) may include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like. The same considerations may be applicable to the cache memory 81. Various embodiments of the processor 80c include but are not limited to general purpose computers, special purpose computers, microprocessors, digital signal processors (DSPs) and multi-core processors. Similar embodiments are applicable to memories and processors in the device 82 shown in FIG. 5.

The record search application module 80e may provide various instructions for performing steps 50-58 shown in FIG. 4 and assist in performing steps 10-18 in FIG. 1, using a communication link 87. The module 80e may be implemented as an application computer program stored in the memory 80d, but in general it may be implemented as software, firmware and/or hardware module or a combination thereof. In particular, in the case of software or firmware, one embodiment may be implemented using a software related product such as a computer readable memory (e.g., non-transitory computer readable memory), computer readable medium or a computer readable storage structure comprising computer readable instructions (e.g., program instructions) using a computer program code (i.e., the software or firmware) thereon to be executed by a computer processor. Furthermore, the module 80e may be implemented as a separate block or may be combined with any other module/block of the device 80, or it may be split into several blocks according to their functionality.

The server device 82 may have similar components as the apparatus 80, as shown in FIG. 5, so that the above discussion about components of the device 80 is fully applicable to the components of the server device 82.

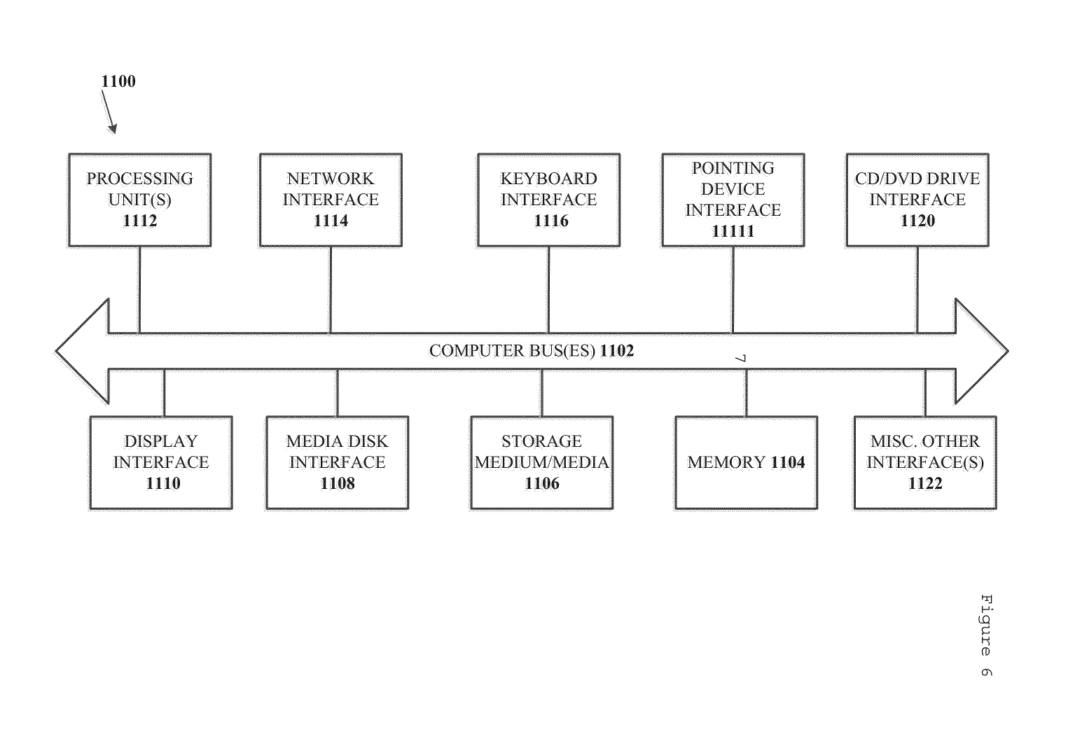

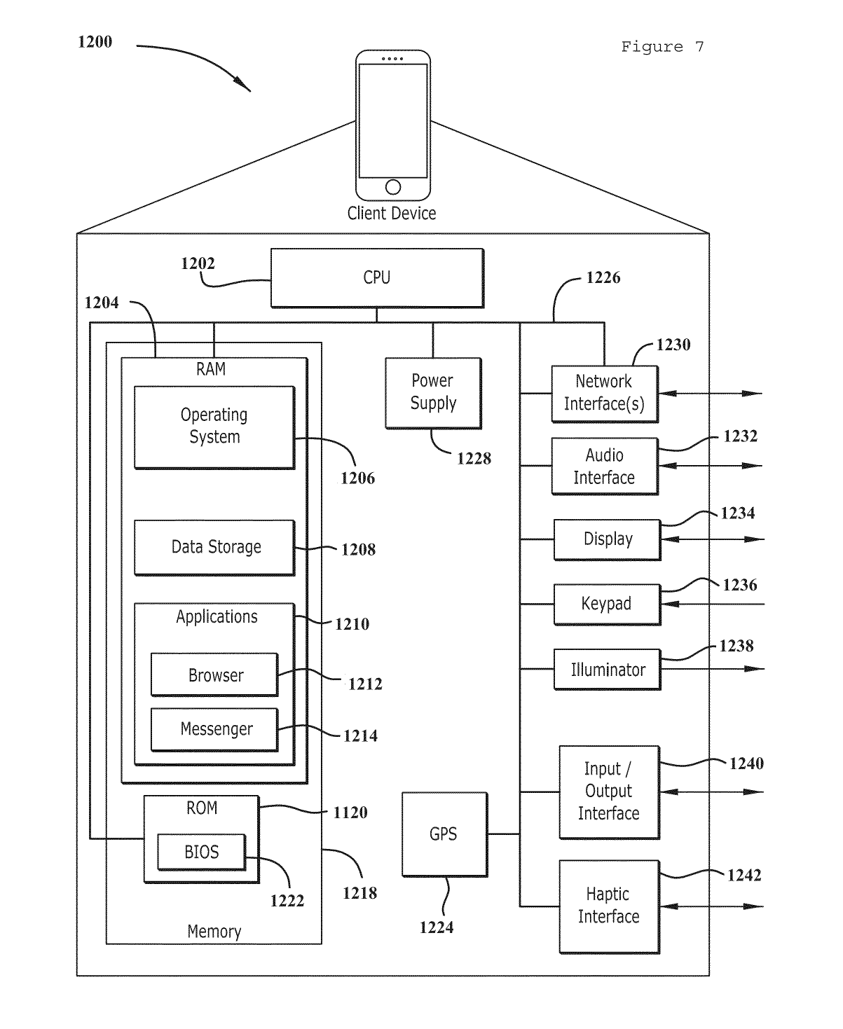

FIGS. 6 and 7 provide further insight for implementation of various embodiments described herein using a computer device. The devices depicted in FIGS. 6 and 7 may interchangeably or in combination perform any of the functions of the user's device, a server or database repository, or any other function described herein.

As shown in the example of FIG. 6, internal architecture of a computing device 1100 includes one or more processing units (also referred to herein as CPUs) 1112, which interface with at least one computer bus 1102. Also interfacing with computer bus 1102 are persistent storage medium/media 1106, network interface 1114, memory 1104, e.g., random access memory (RAM), run-time transient memory, read only memory (ROM), etc., media disk drive interface 1108, an interface 1120 for a drive that can read and/or write to media including removable media such as floppy, CD-ROM, DVD, etc., media, display interface 1110 as interface for a monitor or other display device, keyboard interface 1116 as interface for a keyboard, pointing device interface 1118 as an interface for a mouse or other pointing device, and miscellaneous other interfaces 1122 not shown individually, such as parallel and serial port interfaces, a universal serial bus (USB) interface, and the like.

Memory 1104 interfaces with computer bus 1102 so as to provide information stored in memory 1104 to CPU 1112 during execution of software programs such as an operating system, application programs, device drivers, and software modules that comprise program code or logic, and/or computer-executable process steps, incorporating functionality described herein, e.g., one or more of process flows described herein. CPU 1112 first loads computer-executable process steps or logic from storage, e.g., memory 1104, storage medium/media 1106, removable media drive, and/or other storage device. CPU 1112 can then execute the stored process steps in order to execute the loaded computer-executable process steps. Stored data, e.g., data stored by a storage device, can be accessed by CPU 1112 during the execution of computer-executable process steps.

Persistent storage medium/media 1006 is a computer readable storage medium(s) that can be used to store software and data, e.g., an operating system and one or more application programs. Persistent storage medium/media 1006 can also be used to store device drivers, such as one or more of a digital camera driver, monitor driver, printer driver, scanner driver, or other device drivers, web pages, content files, metadata, playlists and other files. Persistent storage medium/media 1006 can further include program modules and data files used to implement one or more embodiments of the present disclosure.

FIG. 7 is a schematic diagram illustrating a client device implementation of a computing device in accordance with embodiments of the present disclosure. A client device 1200 may include a computing device capable of sending or receiving signals, such as via a wired or a wireless network, and capable of running application software or “apps”. A client device may, for example, include a desktop computer or a portable device, such as a cellular telephone, a smart phone, a display pager, a radio frequency (RF) device, an infrared (IR) device, a Personal Digital Assistant (PDA), a handheld computer, a tablet computer, a laptop computer, a set top box, a wearable computer, an integrated device combining various features, such as features of the forgoing devices, or the like.

A client device may vary in terms of capabilities or features. The client device can include standard components such as a CPU 1202, power supply 1228, a memory 1218, ROM 1220, BIOS 1222, network interface(s) 1230, audio interface 1232, display 1234, keypad 1236, illuminator 1238, I/O interface 1240 interconnected via circuitry 1226. Claimed subject matter is intended to cover a wide range of potential variations. For example, the keypad 1236 of a cell phone may include a numeric keypad or a display 1234 of limited functionality, such as a monochrome liquid crystal display (LCD) for displaying text. In contrast, however, as another example, a web-enabled client device 1200 may include one or more physical or virtual keyboards 1236, mass storage, one or more accelerometers, one or more gyroscopes, global positioning system (GPS) 1224 or other location identifying type capability, Haptic interface 1242, or a display with a high degree of functionality, such as a touch-sensitive color 2D or 3D display, for example. The memory 1218 can include Random Access Memory 1204 including an area for data storage 1208.

A client device 1200 may include or may execute a variety of operating systems 1206, including a personal computer operating system, such as a Windows, iOS or Linux, or a mobile operating system, such as iOS, Android, or Windows Mobile, or the like. A client device 1200 may include or may execute a variety of possible applications 1210, such as a client software application 1214 enabling communication with other devices, such as communicating one or more messages such as via email, short message service (SMS), or multimedia message service (MMS), including via a network, such as a social network, including, for example, Facebook, LinkedIn, Twitter, Flickr, or Google+, to provide only a few possible examples. A client device 1200 may also include or execute an application to communicate content, such as, for example, textual content, multimedia content, or the like. A client device 1200 may also include or execute an application 1212 to perform a variety of possible tasks, such as browsing, searching, playing various forms of content, including locally stored or streamed content, such as, video, or games (such as fantasy sports leagues). The foregoing is provided to illustrate that claimed subject matter is intended to include a wide range of possible features or capabilities.

For the purposes of this disclosure a computer readable medium stores computer data, which data can include computer program code that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

For the purposes of this disclosure a system or module is a software, hardware, or firmware (or combinations thereof), process or functionality, or component thereof, that performs or facilitates the processes, features, and/or functions described herein (with or without human interaction or augmentation). A module can include sub-modules. Software components of a module may be stored on a computer readable medium. Modules may be integral to one or more servers, or be loaded and executed by one or more servers. One or more modules may be grouped into an engine or an application.

It is noted that various non-limiting embodiments described herein may be used separately, combined or selectively combined for specific applications.

Further, some of the various features of the above non-limiting embodiments may be used to advantage without the corresponding use of other described features. The foregoing description should therefore be considered as merely illustrative of the principles, teachings and exemplary embodiments of this invention, and not in limitation thereof.

It is to be understood that the above-described arrangements are only illustrative of the application of the principles of the present invention. Numerous modifications and alternative arrangements may be devised by those skilled in the art without departing from the scope of the invention, and the appended claims are intended to cover such modifications and arrangements.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the user computing device or server or both. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

While the system and method have been described in terms of one or more embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

What is claimed is:

1. A method comprising:
receiving by an electronic device through a user interface a single-action command representing the selection of an element of a table, the table comprising columns, rows and elements of a list of records, where each row corresponds to one record of the list of records and each column corresponds to a predetermined parameter common to all records in the list of records; and
generating by the electronic device, in response to the single-action command, a modified list of records selected from the list of records based on a similarity between the selected element and corresponding elements in the list of records in a column comprising the selected element.

2. The method of claim 1, wherein the single-action command is received by detecting a movement of a cursor to an area proximate the element to be selected, and detecting clicking on a search icon that appears proximate the element.

3. The method of claim 2, wherein the single-action command is received by detecting the movement of a cursor to an area proximate the element to be selected and detecting an action from a group of actions consisting of:
a click in the area of the element,
a long click in the area of the element, and
a double click in the area of the element.

4. The method of claim 1, wherein the electronic device comprises a touch screen used as the user screen interface, and the single-action command is received by detecting a preselected touch proximate the element to be selected.

5. The method of claim 4, wherein the single-action command is received by the preselected touch proximate the element to be selected by detecting an action from a group of actions consisting of:
a tap in the area of the element,
a touch for a preselected time in the area of the element, and
a swipe in the area of the element.

6. The method of claim 1, wherein generating a modified list of records selected from the list of records comprises:
searching a memory of the electronic device storing the list of records to generate the modified list.

7. The method of claim 1, wherein generating a modified list of records selected from the list of records comprises:
sending a search command comprising information corresponding to the selected element to a server device storing the list of records; and
receiving from the server device information comprising the modified list of records.

8. The method of claim 1, further comprising:
displaying the generated modified list of records on a display of the electronic device.

9. The method of claim 8, further comprising:
receiving by the electronic device through the user interface a further single-action command selecting a further element of the modified list, the further element being different from the selected element; and
generating by the electronic device, in response to the further single-action command, a further modified list of records selected from the modified list of records based on similarity between the further element and corresponding elements in the modified list of records in a column comprising the selected further element.

10. The method of claim 1, wherein the list of records comprises a list of e-mails.

11. The method of claim 10, wherein the selected element comprises an e-mail sender's identity.

12. The method of claim 10, wherein the selected element comprises a subject of the e-mail.

13. An apparatus comprising:
a processor;
a storage medium for tangibly storing thereon program logic for execution by the processor, the program logic comprising:
logic to receive through a user interface a single-action command representing the selection of an element of a table, the table comprising columns, rows and elements of a list of records, where each row corresponds to one record of the list of records and each column corresponds to a predetermined parameter common to all records in the list of records; and
logic to generate, in response to the single-action command, a modified list of records selected from the list of records based on a similarity between the selected element and corresponding elements in the list of records in a column comprising the selected element.

14. The apparatus of claim 13, wherein the apparatus comprises a computer, a smartphone, a tablet or a wireless device.

15. The apparatus of claim 13, wherein the program logic comprises:
logic to detect a movement of a cursor to an area proximate the element to be selected, and detecting clicking on a search icon that appears proximate the element.

16. The apparatus of claim 13, wherein the apparatus comprises a touch screen used as the user interface, and the program logic comprises:
logic to receive the single-action command by detecting a preselected touch proximate the element to be selected.

17. The apparatus of claim 13, wherein the program logic comprises:
logic to search a memory or a cache memory of the apparatus storing the list of records to generate the modified list.

18. The apparatus of claim 13, wherein the program logic comprises:
logic to send a search command to a server device storing the list of records; and
logic to receive from the server device information comprising the modified list of records.

19. The apparatus of claim 13, wherein the program logic comprises:
logic to display the generated modified list of records on a display of the apparatus.

20. The apparatus of claim 13, wherein the list of records comprises a list of e-mails.

21. A non-transitory computer readable storage medium tangibly storing computer program instructions capable of being executed by a computer processor, the computer program instructions defining code for:
receiving by an electronic device through a user interface a single-action command representing the selection of an element of a table, the table comprising columns, rows and elements of a list of records, where each row corresponds to one record of the list of records and each column corresponds to a predetermined parameter common to all records in the list of records; and
generating by the electronic device, in response to the single-action command, a modified list of records selected from the list of records based on a similarity between the selected element and corresponding elements in the list of records in a column comprising the selected element.

22. A method comprising:
detecting a single-action command from a user interface of a computing device, the command representing the selection of an element of a table that comprises columns, rows and elements of a list of records, each row of the table corresponding to one record of the list of records and each column of the table corresponding to a predetermined parameter common to all records in the list;
automatically formulating, via the computing device, a search query comprising the selected element;
communicating the search query to a search program capable of searching the list of records based on similarity between the selected element and corresponding elements in the list of records in a column comprising the selected element; and
receiving, in response to the search query, a search result comprising a modified list of records selected from the list of records in accordance with the query.

23. A computing device comprising;
a processor; and
memory for storing program logic, the program logic executed by the processor, the program logic comprising:
logic for detecting a single-action command from a user interface of a computing device, the command representing the selection of an element of a table that comprises columns, rows and elements of a list of records, each row of the table corresponding to one record of the list of records and each column of the table corresponding to a predetermined parameter common to all records in the list;
logic for automatically formulating, via the computing device, a search query comprising the selected element;
logic communicating the search query to a search program capable of searching the list of records based on similarity between the selected element and corresponding elements in the list of records in a column comprising the selected element; and
logic for receiving, in response to the search query, a search result comprising a modified list of records selected from the list of records in accordance with the query.

24. A method comprising:
receiving by an electronic device through a user interface a single-action command representing the selection of an element of a table, the table comprising columns, rows and elements of a list of records, where each column corresponds to one record of the list of records and each row corresponds to a predetermined parameter common to all records in the list of records; and
generating by the electronic device, in response to the single-action command, a modified list of records selected from the list of records based on a similarity between the selected element and corresponding elements in the list of records in a row comprising the selected element.

25. The method of claim 2, wherein after detecting a movement of a cursor to an area proximate the element to be selected, the method further comprising:
providing a search icon proximate the element, an interaction of the user with the icon providing the single-action command.

26. The method of claim 4, wherein after detecting a user interation at an area proximate the element to be selected, the method further comprising:
providing a search icon proximate the element, an interaction of the user with the icon providing the single-action command.

27. The method of claim 26, wherein the user interaction is an interaction chosen from a group of interactions consisting of a slide, a sweep, a tap, a held position, and a touch.
